(19) United States
(12) Patent Application Publication
(10) Pub. No.: US 2014/0122632 A1
(43) Pub. Date: May 1, 2014

(54) CONTROL TERMINAL AND CONTROL METHOD

(71) Applicant: FUJITSU LIMITED, Kawasaki-shi (JP)

(72) Inventors: Hiromasa YAMAUCHI, Usakos (NA); Koichiro YAMASHITA, Hachioji (JP); Takahisa SUZUKI, Yokohama (JP); Koji KURIHARA, Kawasaki (JP); Toshiya OTOMO, Kawasaki (JP); Naoki ODATE, Akiruno (JP)

(73) Assignee: FUJITSU LIMITED, Kawasaki-shi (JP)

(21) Appl. No.: 14/148,293

(22) Filed: Jan. 6, 2014

Related U.S. Application Data
(63) Continuation of application No. PCT/JP2011/065518, filed on Jul. 6, 2011.

(51) Int. Cl. H04L 12/24

(52) U.S. Cl. CPC H04L 41/04
USPC 709/208

(57) ABSTRACT

A control terminal has access to a storage apparatus storing a first processing period for execution of an application by sequential processing and a second processing period for execution of the application by parallel processing; and includes a processor configured to transmit an execution request for the application to a request terminal upon accepting a startup instruction for the application; receive a response to the execution request; determine whether a sum of the second processing period and a difference of a reception time of the response and a transmission time of the execution request, is at least the first processing period; and execute the application by sequential processing by the control terminal when the sum is at least equal to the first processing period, and execute the application by parallel processing using the control terminal and the request terminal when the sum is less than the first processing period.

### CROSS REFERENCE TO RELATED APPLICATIONS

This application is a continuation application of International Application PCT/JP2011/065518, filed on Jul. 6, 2011 and designating the U.S., the entire contents of which are incorporated herein by reference.

### FIELD

The embodiments discussed herein are related to a control terminal and a control method that control execution of an application.

### BACKGROUND

According to a conventional technique, plural computers execute an application (hereinafter, referred to as “app”) by distributed, parallel processing through a network. According to another recent technique, plural portable terminals execute parallel processing through a network.

For example, according to a related technique, when loop calculations are executed in parallel and data for the loop calculations have dependence relations, a system is constructed such that the number of communication sessions among the computers is reduced. For example, according to another technique, a computer that manages parallel processing assigns the processing based on the resource use state of other computers. For examples, refer to Japanese Laid-Open Patent Publication Nos. 2008-3907, 2002-358291, and H5-158895.

However, for a portable terminal that communicates via a radio network, for example, when the portable terminal moves accompanying the movement of the person carrying the portable terminal, the communication condition varies. Therefore, when plural portable terminals execute parallel processing, the relative lengths of the processing time period for an app and the time period for transferring the data change. Therefore, a problem arises in that, depending on the app, the performance of the app drops consequent to executing the app by parallel processing by the plural portable terminals.

### SUMMARY

According to an aspect of an embodiment, a control terminal is configured to enable access of a storage apparatus storing a first processing time period that is consumed when an application that is to be executed is executed by sequential processing and a second processing time period that is consumed when the application is executed by parallel processing. The control terminal includes a processor that is configured to transmit an execution request for the application to a request destination terminal upon accepting a startup instruction for the application; receive from the request destination terminal, a response to the transmitted execution request; determine whether a sum of the second processing time period and a difference of a reception time of the response and a transmission time of the execution request, is at least equal to the first processing time period; and execute the application by sequential processing by the control terminal upon determining that the sum is at least equal to the first processing time period, and execute the application by parallel processing using the control terminal and the request destination terminal upon determining that the sum is not at least equal to the first processing time period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of an example of a communication system;

FIG. 2 is an explanatory diagram of an example of a performance index used in parallel processing;

FIG. 3 is a block diagram of an example of hardware of portable terminals;

FIG. 4 is an explanatory diagram of an example of an app-specific data table;

FIG. 5 is an explanatory diagram of an example of a shared data table;

FIG. 6 is an explanatory diagram of an example of an app table;

FIG. 7 is an explanatory diagram of an example of functional blocks of a communication system 100;

FIG. 8 is an explanatory diagram of an example;

FIGS. 9 and 10 are flowcharts of an example of a procedure for a process executed by a master portable terminal 110; and

FIG. 11 is a flowchart of an example of a procedure for a process executed by a slave portable terminal 111.

### DESCRIPTION OF EMBODIMENTS

Embodiments of a control terminal and a control method will be described in detail with reference to the accompanying drawings.

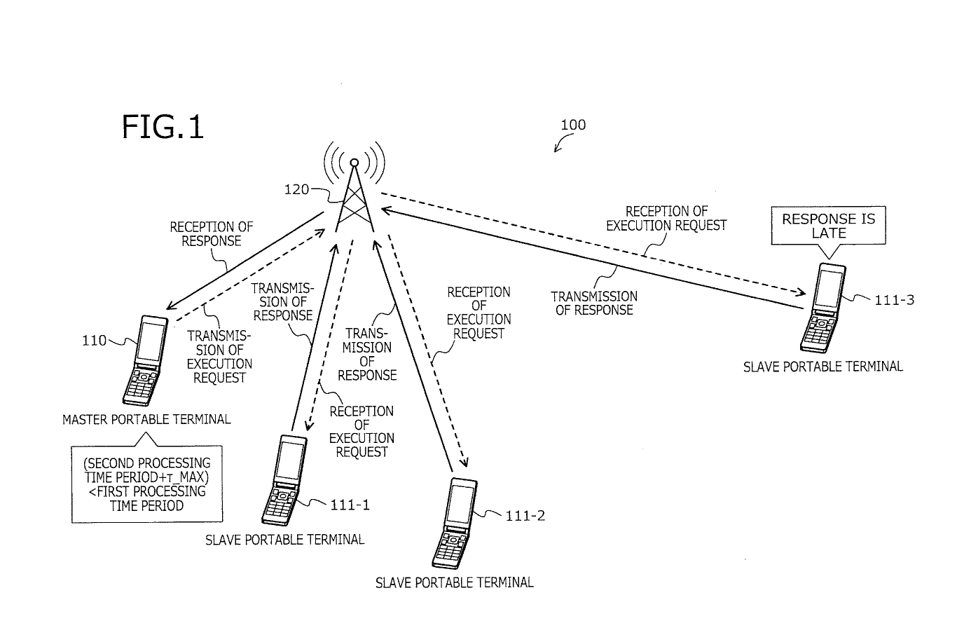

FIG. 1 is an explanatory diagram of an example of a communication system. A communication system 100 includes a master portable terminal 110, slave portable terminals 111-1 to 111-3, and a base station 120. For this system, it is assumed that the slave portable terminals 111 by which the master portable terminal 110 executes parallel processing are determined in advance, and that the master portable terminal 110 and the slave portable terminals 111-1 to 111-3 mutually know the addresses of each other. The number of slave portable terminals 111 suffices to be one or more, and is three in the example depicted in FIG. 1. The master portable terminal 110 is a control terminal and the slave portable terminals 111-1 to 111-3 are request destination terminals. Although the portable terminals communicate with one another via the base station 120 in the example depicted in FIG. 1, the portable terminals may communicate with one another without the base station 120, such as by ad-hoc communication.

For a PC or a server, the installation thereof is fixed. However, for a portable terminal, the person carrying the portable terminal may change locations and thus, the signal intensity for communication among the portable terminals and the base station 120 may change. The communication conditions for data may vary moment-to-moment between the master portable terminal 110 and the slave portable terminals 111-1 to 111-3.

When the master portable terminal 110 receives a startup instruction for an app that is to be executed and is executable by parallel processing by plural portable terminals, the master portable terminal 110 transmits an execution request to each of the slave portable terminals 111-1 to 111-3. An “app that is to be executed and is executable by parallel processing by plural portable terminals” may be, for example, an app related to streaming.

When the slave portable terminals 111-1 to 111-3 each receives the execution request, the slave portable terminals 111-1 to 111-3 each transmits a response to the master portable terminal 110. In the example of FIG. 1, the communication conditions for the slave portable terminal 111-3 has deteriorated and therefore, the transmission of the response to the master portable terminal 110 is delayed. In an example of the present embodiment, the time period from the transmission time of shared data to the reception time of the most delayed response is handled as an overhead τ and is caused by communication conditions.

The master portable terminal 110 determines whether the sum of the overhead τ and a second processing time period that is consumed when the app to be executed is executed by parallel processing by the plural portable terminals, is less than a first processing time period consumed when the app is executed by sequential processing by the master portable terminal 110. The “plural portable terminals” refers to the master portable terminal 110 and the slave portable terminals 111-1 to 111-3. If the master portable terminal 110 determines that the sum is less than the first processing time period, the master portable terminal 110 executes the app by parallel processing using the plural portable terminals and if the master portable terminal 110 determines that the sum is equal to the first processing time period or longer, the master portable terminal 110 executes the app by sequential processing, by the master portable terminal 110.

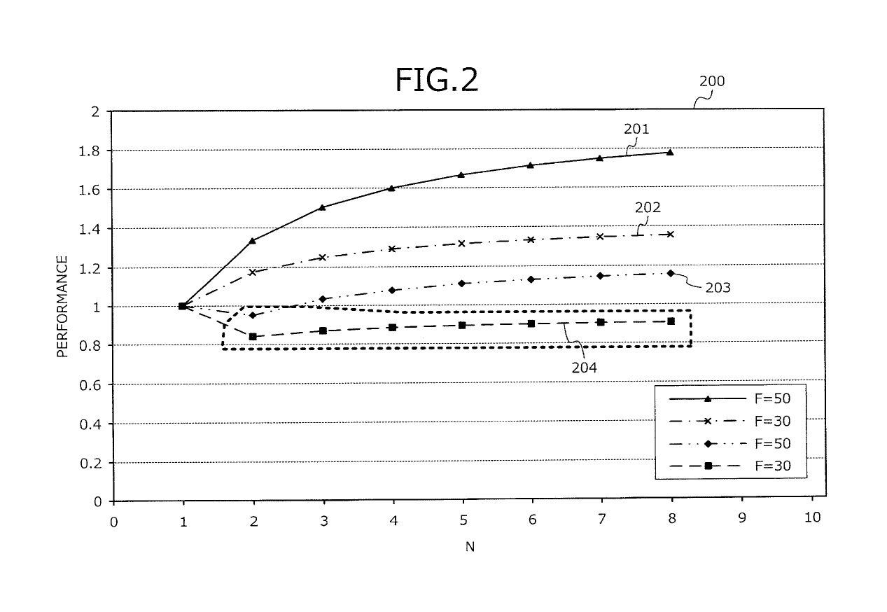

FIG. 2 is an explanatory diagram of an example of a performance index used in the parallel processing. In graph 200, examples are plotted that are obtained by adding several overheads to values according to Amdahl's law, which provides the performance index for the parallel processing. The horizontal direction of the graph 200 represents “N (number of nodes)” and the vertical direction represents the performance. “N (number of nodes)” in the graph 200 represents the number of portable terminals and is the number obtained when it is assumed that hardware such as the CPU is identical for each of the portable terminals. The performance in the graph 200 is represented assuming that the performance is one when N is N=1.

Eq. (1) expresses the performance index and is indicated below.

T(N)=(1−(1−F)/N)×T(1)+τ (1)

Where, “F” represents the ratio of the processing time period for sequentially processing a portion that cannot be processed in parallel. The ratio of the processing time period for a portion that can be processed in parallel is (1−F). “τ” represents the overhead. “T(1)” represents the processing time period consumed when the application is executed by only one portable terminal. As indicated by a broken line 201 that includes black triangles, F is 50 [%]. As indicated by a broken line 202 that includes cross marks, F is 30 [%]. The broken lines 201 and 202 depicted ideal values and therefore, the respective overheads thereof are zero. As indicated by a broken line 203 that includes black diamonds, F is 50 [%] and as indicated by a broken line 204 that includes black squares, F is 30 [%]. The broken lines 203 and 204 each includes T.

As indicated by the broken line 203, although the performance is less than one when N is N=2, the performance is greater than or equal to one when N is N=3 to 8. As indicated by the broken line 204, the performance is less than one when N is N=2 to 8. In other words, compared to a case where the app is executed by parallel processing, higher performance may be acquired by sequential processing.

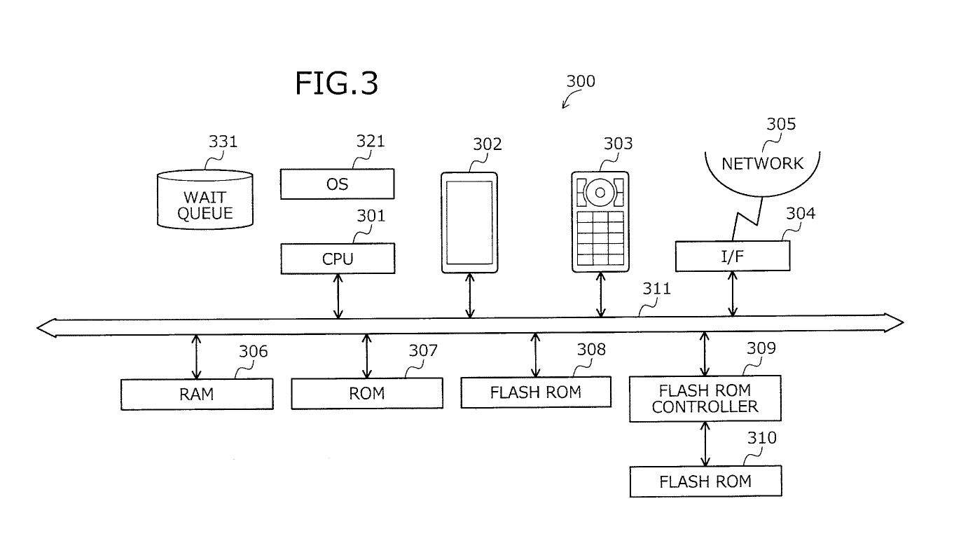

FIG. 3 is a block diagram of an example of hardware of the portable terminals (the master portable terminal 110 and the slave portable terminals 111-1 to 111-3). A portable terminal 300 includes a CPU 301, a display 302, a keyboard 303, an interface (I/F) 304, random access memory (RAM) 306, read only memory (ROM) 307, flash ROMs 308 and 310, and a flash ROM controller 309. The components from the CPU 301 to the I/F 304, and the RAM 306 to the flash ROM controller 309 are connected to each other through a bus 311.

The CPU 301 supervises the overall control of the portable terminal 300, and includes a register, a core, and a cache. The core has a computing function. The register in each CPU 301 includes a program counter (PC) and a reset register. The CPU 301 executes an OS 321 and the OS 321 executes threads assigned to the portable terminal 300. The OS 321 includes a wait queue 331. When an app is loaded into the wait queue 331, the OS 321 determines that a startup instruction has been received for the app.

The display 302 displays data such as a document, an image, and functional information in addition to a cursor, an icon, or a toolbox. For example, a TFT liquid crystal display may be employed as the display 302. The keyboard 303 includes keys for inputting numbers, various instructions, etc., and is used to input data. The keyboard 303 may be a touch panel input pad, a numerical keypad, etc.

The I/F 304 is connected to a network 305 such as a local area network (LAN), a wide area network (WAN), or the Internet through a radio communication line; and is connected to other portable terminals through the network 305. The I/F 304 supervises an interface between the network 305 and internal components, and controls the input and output of data with respect to external apparatuses. For example, a radio communication modem or a LAN adaptor may be employed as the I/F 304.

The ROM 307 stores programs such as a boot program. The RAM 306 is used as a work area for each CPU 301. The flash ROM 308 stores system software such as the OS 321 and programs of applications. From each CPU 301, the access speed to the RAM 306 is higher than that to the flash ROM 308. Loading of a program of an application from the flash ROM 308 to the RAM 306 by the OS 321 causes context information of the application to be expanded in the RAM 306.

The flash ROM controller 309 controls the reading and writing of data with respect to the flash ROM 310 under the control of each CPU 301. The flash ROM 310 stores data that is written thereto under the control of the flash ROM controller 309. An example of the data may be image data or video image data acquired through the I/F 304 by a user of the terminal. For example, a memory card or an SD card may be employed as the flash ROM 310.

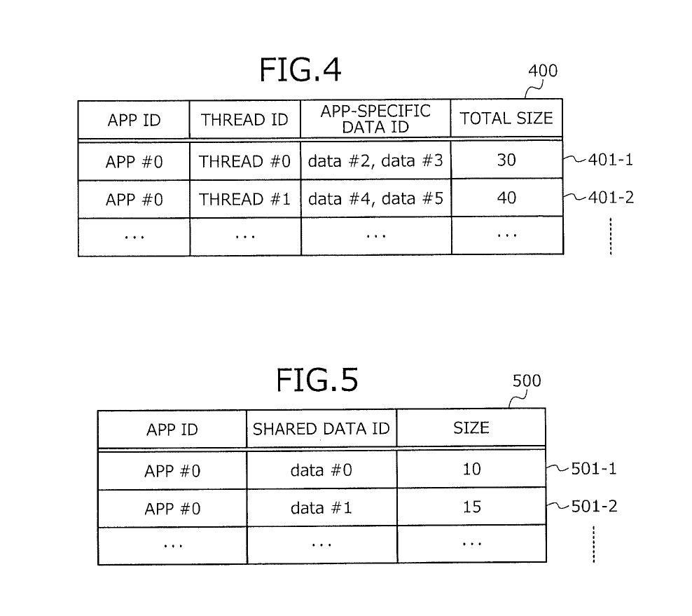

FIG. 4 is an explanatory diagram of an example of an app-specific data table. An app-specific data table 400 includes fields for the app ID, the thread ID, the app-specific data ID, and the total size. App-specific information is stored as records (for example, 401-1 and 401-2) by setting information in each of the fields.

Identification information of the app is registered into the app ID field. Identification information of a thread included in the app is registered into the thread ID field. Identification information of app-specific data uniquely retained by the thread is registered into the app-specific data ID field. The total size of the app-specific data retained by the thread is registered into the total size field.

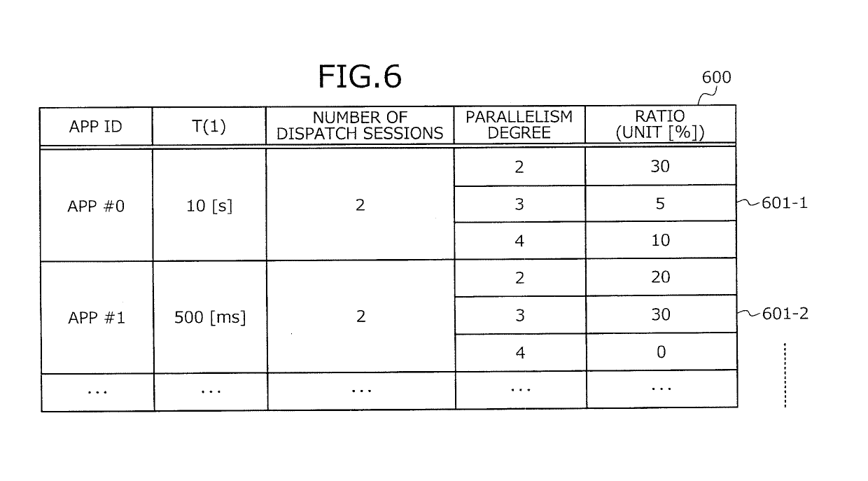

FIG. 5 is an explanatory diagram of an example of a shared data table. A shared data table 500 includes fields for the app ID, the shared data ID, and the size. Shared information is stored as records (for example, 501-1 and 501-2) by setting information in each of the fields.

Identification information of the app is registered into the app ID field. Identification information of shared data shared among all the threads in the app is registered into the shared data field. The size of the shared data is registered into the size field.

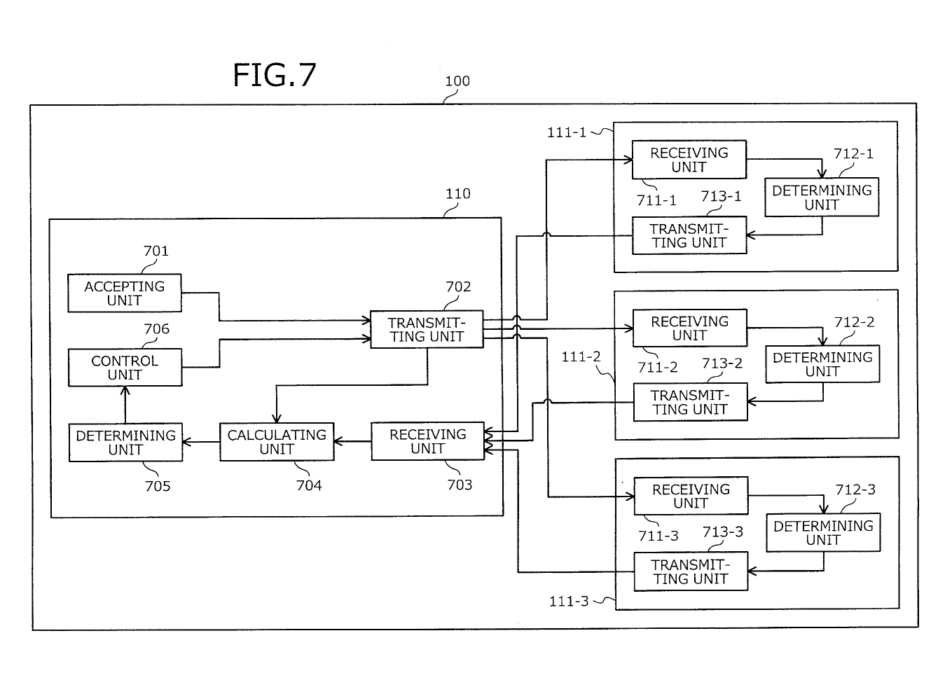

FIG. 6 is an explanatory diagram of an example of an app table. An app table 600 includes fields for the app ID, T(1), the number of dispatch sessions, the parallelism degree, and the ratio. App information is stored as records (for example, 601-1 and 601-2) by setting information in each of the fields.

Identification information of the app is registered into the app ID field. The processing time period consumed when the app is executed by sequential processing by one portable terminal is registered into T(1) field. For example, T(1) is calculated by simulation when the app is designed. The number of assignment sessions occurring for each thread retained by the app is registered into the number of dispatch session field. For example, when a loop process that can be executed by the parallel processing is present, dispatch sessions occur for at least the number of loop sessions. The ratio of the app executable by parallel processing using the portable terminals of the number registered in the parallelism degree field, is registered into the ratio field.

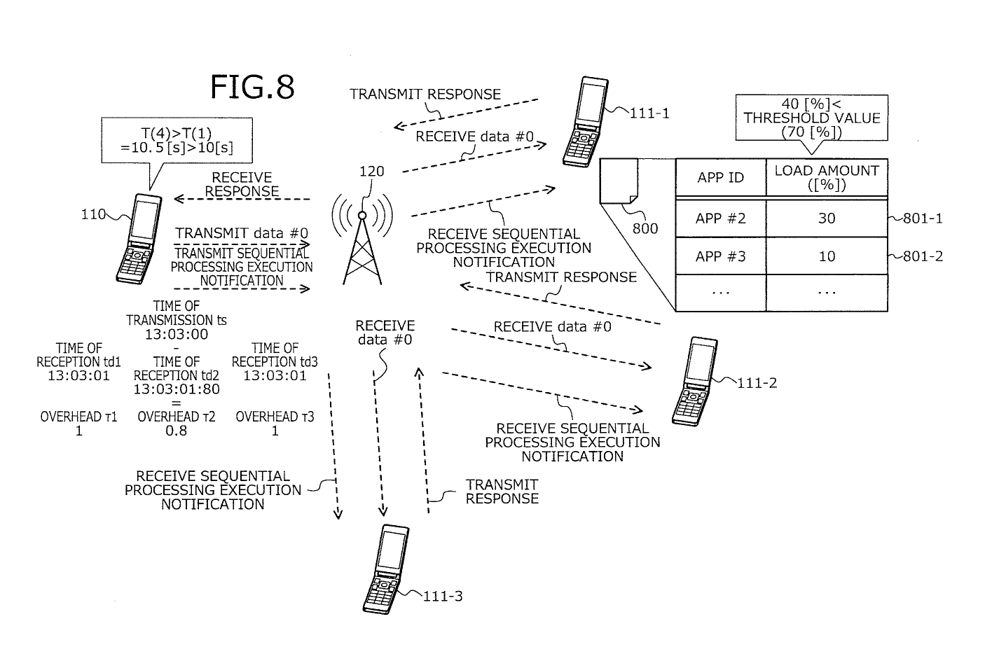

FIG. 7 is an explanatory diagram of an example of functional blocks of the communication system 100. The master portable terminal 110 includes an accepting unit 701, a transmitting unit 702, a receiving unit 703, a calculating unit 704, a determining unit 705, and a control unit 706. The accepting unit 701 to the control unit 706 are, for example, coded in a control program, and the control program is stored in a storage apparatus such as the ROM 307 or the flash ROM 308 or 310 depicted in FIG. 3. The CPU 301 reads the control program from a storage apparatus and executes the processes coded in the control program. Thereby, the processes operating as the accepting unit 701 to the control unit 706 are executed. The control program is, for example, the OS 321 depicted in FIG. 3.

The slave portable terminal 111-n (n=1 to 3) includes a receiving unit 711-n, a determining unit 712-n, and a transmitting unit 713-n. The accepting unit 711-n to the transmitting unit 713-n are, for example, coded in the control program, and the control program is stored in a storage apparatus such as the ROM 307 or the flash ROM 308 or 310 depicted in FIG. 3. The CPU 301 reads the control program from the storage apparatus and executes the processes coded in the control program. Thereby, the processes operating as the receiving unit 711-n to the transmitting unit 713-n are executed. The control program is, for example, the OS 321 depicted in FIG. 3.

The accepting unit 701 accepts the startup instruction for the app to be executed. For example, the accepting unit 701 monitors the loading of the app to be executed onto the wait queue 331 and accepts the loaded app to be executed as the app for which the startup instruction is issued.

When the app accepted by the accepting unit 701 is an app that is to be executed by parallel processing using the plural portable terminals, the transmitting unit 702 transmits to the slave portable terminal 111-n, shared data having the smallest data size among the shared data retained by the app to be executed. For example, the transmitting unit 702 identifies from the shared data table 500 and based on the identification information of the app to be executed, the shared data that has the smallest data size among the shared data of the app to be executed; transmits the shared data to the slave portable terminal 111-n; acquires the transmission time thereof; and outputs the acquired transmission time.

The receiving unit 711-n receives the shared data transmitted from the master portable terminal 110. The determining unit 712-n determines whether the sum of the load amounts of the currently executed app and that of an app standing by for execution is greater than or equal to a threshold value. For example, the “load amount” refers to the processing time period per unit time.

If the determining unit 712-n determines that the sum of the load amounts is less than the threshold value, the transmitting unit 713-n transmits to the master portable terminal 110, a response to the receipt of the shared data. If the determining unit 712-n determines that the sum of the load amounts is not less than the threshold value, the transmitting unit 713-n does not transmit a response to the master portable terminal 110. The transmitting unit 713-n transmits a response to the master portable terminal 110 when the slave portable terminal 111-n has a capacity to execute the thread retained by the app to be executed, and does not transmit a response to the master portable terminal 110 when the slave portable terminal 111-n has no such capacity.

The receiving unit 703 receives the response from the slave portable terminal 111-n within a specific time period. For example, the receiving unit 703 monitors the time period elapsing from the transmission time and thus, waits for the response only for the specific time period. For example, when the receiving unit 703 receives the response from the slave portable terminal 111-n, the receiving unit 703 correlates and outputs identification information concerning the slave portable terminal 111-n and the reception time. For example, after the specific time period elapses, the receiving unit 703 discontinues the wait for a response from the slave portable terminal 111-n.

The calculating unit 704 calculates the second processing time period based on the number of slave portable terminals 111 from which a response is received, including the master portable terminal 110. The calculating unit 704 further calculates the first processing time period. The “first processing time period” is the processing time period consumed when the app to be executed is executed by sequential processing by one portable terminal. The “second processing time period” is the processing time period consumed when the app to be executed is executed by parallel processing using the above number of portable terminals. The determining unit 705 determines whether the sum of the second processing time period and the difference of the transmission time of the shared data by the transmitting unit 702 and the reception time of the response by the receiving unit 703, is greater than or equal to the first processing time period.

For example, the calculating unit 704 acquires from the app table 600 and as the first processing time period, T(1), which is the time consumed when the app to be executed is executed by sequential processing by one portable terminal. The calculating unit 704 further acquires the ratio for each parallelism degree. For example, the calculating unit 704 and the determining unit 705 calculate Eqs. (2) and (3) below.

τn=tdn−ts (2)

T(N)=(F(1)+F(2)/2+F(N−1)/(N−1))×T(1)+τ_MAX×M (3)

Where, “tdn (n=1 to 3)” is the reception time at which the response is received. “td1”, “td2”, and “td3” are the reception times at which the responses respectively from the slave portable terminals 111-1 to 111-3 are received. “ts” is the transmission time at which the shared data is transmitted.

“τn (n=1 to 3)” is the overhead concerning the communication state of the slave portable terminal 111-n, and is the time period from the transmission time at which the master portable terminal 110 transmits the shared data until the reception time at which the master portable terminal 110 receives a response. “τ1”, “τ2”, and “τ3” are the overheads respectively concerning the communication states of the slave portable terminals 111-1 to 111-3.

“τ_MAX” is the longest time period among τ1 to τ3. “T(1)” is the first processing time period. “N” is (the number of slave portable terminals each transmitting a response)+1. “P” is the execution ratio. “M” is the number of dispatch sessions. “τ_MAX×M” is the overhead. In Eq. (3), the portion remaining after excluding τ_MAX×M is the second processing time period and “T(N)” is the sum of the second processing time period and the overhead. The second processing time period may be preliminarily listed in a table. For example, the determining unit 705 determines whether the calculated T(N) is longer than or equal to T(1).

If the determining unit 705 determines that T(N) is longer than or equal to T(1), the control unit 706 causes sequential processing to be executed. For example, the control unit 706 transmits sequential processing execution notification to each of the slave portable terminals 111 that have transmitted a response, and starts the execution process for the app that is to be executed.

If the determining unit 705 determines that T(N) is not longer than or equal to T(1), the control unit 706 causes the slave portable terminals 111 that have transmitted a response and the master portable terminal 110 to execute the app, by the parallel processing. For example, the control unit 706 identifies the threads retained by the app to be executed in descending order of the size of the app-specific data.

For example, the control unit 706 assigns the threads in descending order of the size of the app-specific data to the slave portable terminals 111 in ascending order of the size of the calculated overhead. For example, the control unit 706 transmits, by the transmitting unit 702, a shared data group of the app that is to be executed, excluding the shared data identified to be the smallest in size in the shared data group.

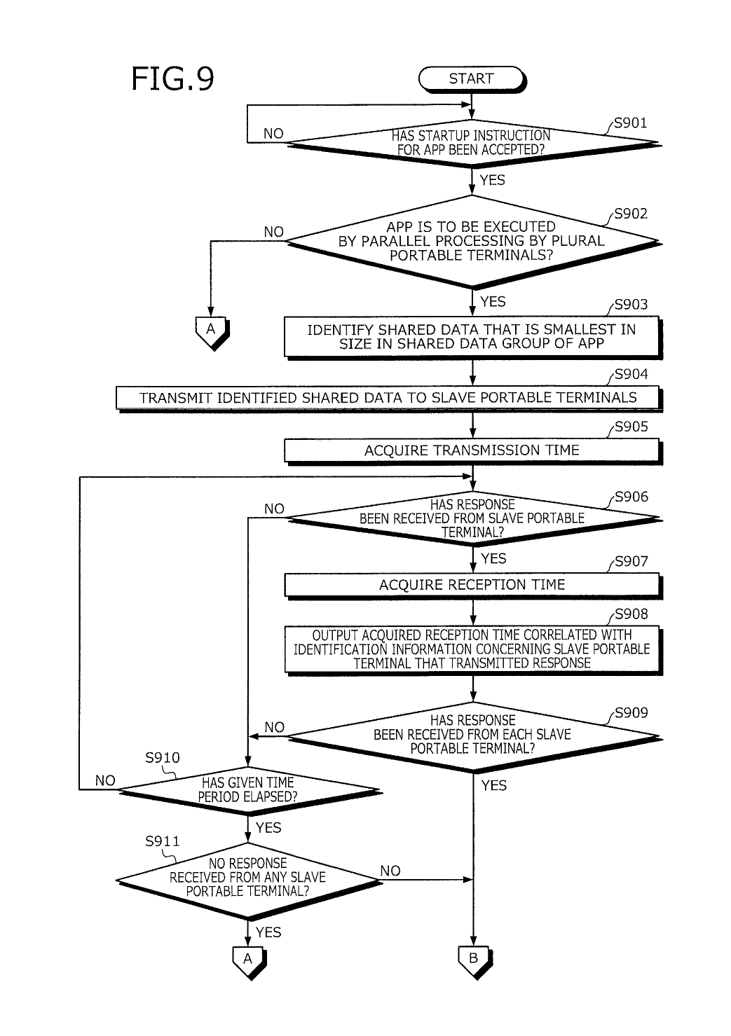

FIG. 8 is an explanatory diagram of an example. In FIG. 8, an example is described where the app to be executed is an app #0. Shared data of the app #0 can be identified by referring to the shared data table 500. The shared data of the app #0 are data #0 and #1. The shared data that is smallest in size is data #0 and therefore, the data #0 is transmitted to each of the slave portable terminals 111.

The slave portable terminal 111 calculates the sum of the load amounts of the app under execution and the app standing by for execution, based on a load amount table 800. The load amount table 800 includes fields for the app ID and the load amount. Load amount information is stored as records (for example, 801-1 and 801-2) by setting information in each field. The identification information of the application is registered into the app ID field. The load amount of the application is registered into the load amount field.

For example, assuming that the slave portable terminal 111-1 currently executes apps #2 and #3, the slave portable terminal 111-1 calculates the sum of the load amounts of the apps #2 and #3. The sum is 40 [%]. The slave portable terminal 111-1 determines whether the sum is greater than or equal to a threshold value (for example, 70 [%]). In this case, the slave portable terminal 111-1 determines that the sum is less than the threshold value and therefore, transmits to the master portable terminal 110, a response to the receipt of the data #0.

For example, it is assumed that the transmission time of the data #0 and the reception time of the response from the slave portable terminal 111-n are as below. In this case, it is also assumed that the response is transmitted from each of the slave portable terminals 111.

The transmission time ts: 13:03:00

The reception time td1 (the response from the slave portable terminal 111-1): 13:03:01

The reception time td2 (the response from the slave portable terminal 111-2): 13:03:01.80

The reception time td3 (the response from the slave portable terminal 111-31): 13:03:01

The overheads concerning the communication conditions of the slave portable terminals 111 are as below.

Overhead τ1: 1 [sec]
Overhead τ2: 0.8 [sec]
Overhead τ3: 1 [sec]
Overhead τ_MAX: 1 [sec]

T(N) calculated based on Eq. (3) as indicated below. T(1) is 10 [sec] and the number of dispatch sessions is two.

$$\begin{matrix}T ( 4 ) = ( 30 [ \% ] + 40 [ \% ] / 2 + 15 [ \% ] / 3 ) \times 10 [ s ] + 1 [ s ] \times 5 \\ = ( 55 [ \% ] ) \times 10 [ s ] + 5 [ s ] \\ = 5.5 [ s ] + 5 [ s ] \\ = 10.5 [ s ]\end{matrix}$$

T(4) is longer than T(1) and therefore, the master portable terminal 110 transmits sequential execution process notification to the slave portable terminal 111-n that have transmitted a response, and executes the app #0 by sequential processing; and further executes the app #0 by sequential processing. When the slave portable terminal 111-n receives the sequential execution process notification, the slave portable terminal 111-n discards the data #0.

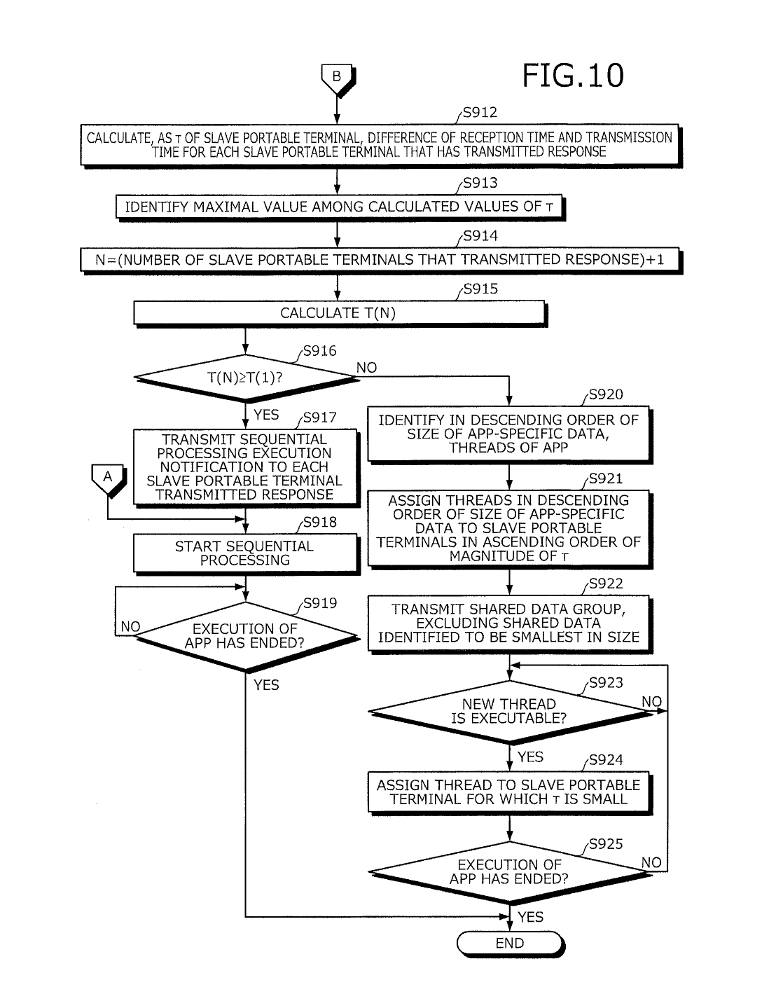

FIGS. 9 and 10 are flowcharts of an example of a procedure for a process executed by the master portable terminal 110. The master portable terminal 110 determines whether the accepting unit has accepted a startup instruction for an app (step S901). If the master portable terminal 110 determines that the accepting unit has not accepted startup instruction for an app (step S901: NO), the procedure returns to step S901.

If the master portable terminal 110 determines that the accepting unit has accepted a startup instruction for an app (step S901: YES), the master portable terminal 110 determines whether the app for which the startup instruction has been accepted (the app to be execute) is to be executed by parallel processing by plural portable terminals (step S902). It is assumed that whether the app is to be executed by parallel processing is determined based on, for example, whether the identification information of the app to be executed is registered in the table.

If the master portable terminal 110 determines that the app to be executed is not app to be executed by parallel processing by plural portable terminals (step S902: NO), the procedure progresses to step S918. If the master portable terminal 110 determines that the app to be executed is an app to be executed by parallel processing by plural portable terminals (step S902: YES), the master portable terminal 110 identifies the shared data that is the smallest in size in the shared data group of the app to be executed (step S903). The master portable terminal 110 transmits the identified shared data to slave portable terminals 111 (step S904), acquires the transmission time (step S905), and determines whether the master portable terminal 110 has received a response from a slave portable terminal 111 (step S906).

If the master portable terminal 110 determines that the master portable terminal 110 has received no response from a slave portable terminal 111 (step S906: NO), the procedure progresses to step S910. If the master portable terminal 110 determines that the master portable terminal 110 has received a response from a slave portable terminal 111 (step S906: YES), the master portable terminal 110 acquires the reception time thereof (step S907) and outputs the acquired reception time correlated with identification information concerning the slave portable terminal 111 that is the transmission source of the response (step S908). The master portable terminal 110 determines whether the master portable terminal 110 has received a response from each of the slave portable terminals 111 (step S909).

If the master portable terminal 110 determines that the master portable terminal 110 has not received a response from each of the slave portable terminals 111 (step S909: NO), the master portable terminal 110 determines whether a given time period has elapsed (step S910). If the master portable terminal 110 determines that the given time period has not elapsed (step S910: NO), the procedure returns to step S906.

If the master portable terminal 110 determines that the specific time period has elapsed (step S910: YES), the master portable terminal 110 determines whether the master portable terminal 110 has received no response from any of the slave portable terminals 111 (step S911). If the master portable terminal 110 determines that the master portable terminal 110 has received no response from any of the slave portable terminals 111 (step S911: YES), the procedure progresses to step S918.

If the master portable terminal 110 determines that the master portable terminal 110 has received a response from any one of the slave portable terminals 111 (step S911: NO), the procedure progresses to step S912. If the master portable terminal 110 determines at step S909 that the master portable terminal 110 has received a response from each of the slave portable terminals 111 (step S909: YES), the procedure progresses to step S912.

Following the case of (step S911: NO) or (step S909: YES), the master portable terminal 110 calculates, as τ of the slave portable terminals 111, the difference of the reception time and the transmission time for each of the slave portable terminals 111 that has transmitted a response (step S912). The master portable terminal 110 identifies the maximal value among the calculated values of τ of the slave portable terminals 111 (step S913), sets N to be N=(the number of slave portable terminals 111 that transmitted a response)+1 (step S914), calculates T(N) (step S915), and determines whether T(N)≧T(1) is true (step S916).

If the master portable terminal 110 determines that T(N)≧T(1) is true (step S916: YES), the master portable terminal 110 transmits sequential processing execution notification to each of the slave portable terminals 111 that transmitted a response (step S917), starts the sequential processing (step S918), and determines whether the execution of the app has come to an end (step S919).

If the master portable terminal 110 determines that the execution of the app to be executed has not come to an end (step S919: NO), the procedure returns to step S919. If the master portable terminal 110 determines that the execution of the app to be executed has come to an end (step S919: YES), the series of process steps come to an end.

If the master portable terminal 110 determines that T(N)≧T(1) is not true (step S916: NO), the master portable terminal 110 identifies in descending order of the size of the app-specific data, the threads of the app (step S920) and assigns the threads in descending order of the size of the app-specific data to the slave portable terminals 111 in ascending order of magnitude of τ (step S921). For example, the master portable terminal 110 refers to the app-specific data table 400 and thereby, identifies the threads having app-specific data whose size is large. The master portable terminal 110 transmits the shared data group, excluding the shared data identified to be smallest in size (step S922).

The master portable terminal 110 determines whether the new thread is executable (step S923). If the master portable terminal 110 determines that the new thread is not executable (step S923: NO), the procedure returns to step S923. If the master portable terminal 110 determines that the new thread is executable (step S923: YES), the master portable terminal 110 assigns the thread to the slave portable terminal 111 for which z is small (step S924) and determines whether the execution of the app to be executed has come to an end (step S925).

If the master portable terminal 110 determines that the execution of the app to be executed has not come to an end (step S925: NO), the procedure returns to step S923. If the master portable terminal 110 determines that the execution of the app to be executed has come to an end (step S925: YES), the series of process steps come to an end.

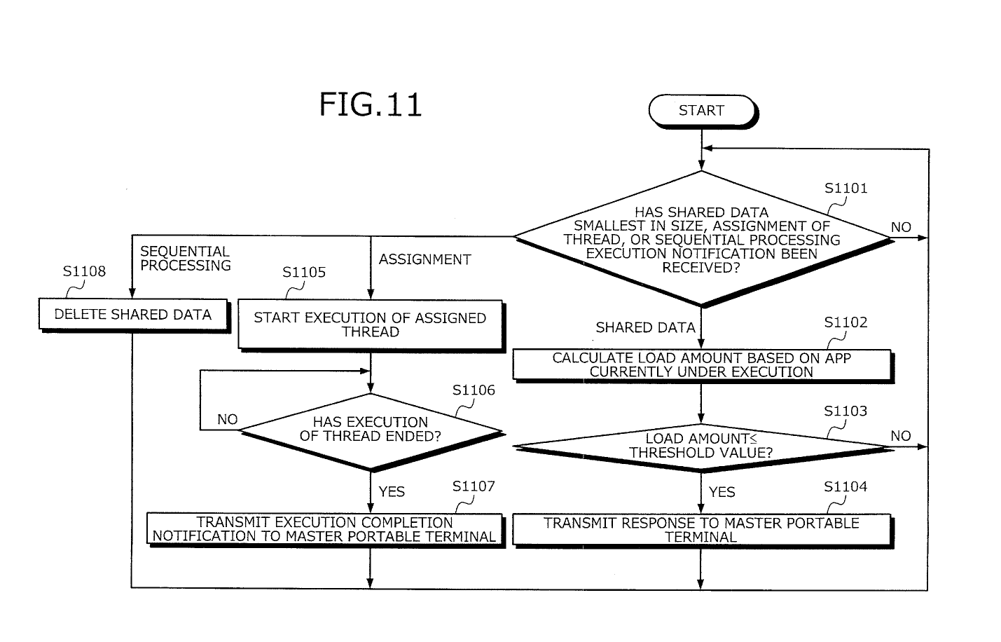

FIG. 11 is a flowchart of an example of a procedure for a process executed by the slave portable terminal 111. The slave portable terminal 111 determines whether the slave portable terminal 111 has received any one among shared data whose size is the smallest among the shared data of an app to be executed, an assignment of a thread, and sequential processing execution notification (step S1101). If the slave portable terminal 111 determines that the slave portable terminal 111 has not received shared data whose size, an assignment of a thread, or sequential processing execution notification (step S1101: NO), the procedure returns to step S1101.

If the slave portable terminal 111 determines that the slave portable terminal 111 has received shared data whose size is the smallest among the shared data of an app to be executed (step S1101: SHARED DATA), the slave portable terminal 111 calculates the load amount based on the app currently under execution (step S1102) and determines whether the load amount and the threshold value have a relation of the load amount≦the threshold value (step S1103). If the slave portable terminal ill determines that the load amount and the threshold value have a relation of the load amount≦the threshold value (step S1103: YES), the slave portable terminal 111 transmits a response to the master portable terminal 110 (step S1104) and the procedure returns to step S1101. If the slave portable terminal 111 determines that the load amount and the threshold value do not have a relation of the load amount≦the threshold value (step S1103: NO), the procedure returns to step S1101.

If the slave portable terminal 111 determines that the slave portable terminal 111 has received an assignment of a thread (step S1101: ASSIGNMENT), the slave portable terminal 111 starts the execution of the assigned thread (step S1105) and determines whether the execution of the thread has come to an end (step S1106). If the slave portable terminal 111 determines that the execution of the thread has not come to an end (step S1106: NO), the procedure returns to step S1106.

If the slave portable terminal 111 determines that the execution of the thread has come to an end (step S1106: YES), the slave portable terminal 111 transmits execution completion notification to the master portable terminal 110 (step S1107). If the slave portable terminal 111 determines that the slave portable terminal 111 has received the sequential processing execution notification (step S1101: SEQUENTIAL PROCESSING), the slave portable terminal 111 deletes the shared data (step S1108) and the procedure returns to step S1101.

As described, even for an app that is executable by parallel processing by plural terminals, if the processing time period thereof by the parallel processing is acquired taking into consideration the overhead concerning the communication conditions before execution and exceeds the processing time by sequential processing, the app is executed by the sequential processing. The time period from the transmission time of the execution request to the reception time of the response is used as a measure of the overhead for the execution. Thereby, any degradation of the performance of the app caused by the communication can be prevented, and the performance of the app during the sequential processing can be ensured.

When plural slave portable terminals are present, the difference between the transmission time of the execution request and the reception time of the slowest response is taken as the overhead and thereby, the lowest quality state of the communication during the execution can be assumed.

The value acquired by multiplying the difference by the number of dispatch sessions is taken as the overhead and thereby, even when the threads retained by the app are numerous, the processing time period of the parallel processing can be estimated more accurately.

The master portable terminal receives only the responses arriving within a specific time period from the transmission time of the execution request and thereby, any degradation of the response performance of the app can be prevented.

The master portable terminal transmits the shared data instead of the execution request and thereby, preparation for parallel processing can be executed and the performance of the app during parallel processing can be improved.

When the load amount of an app that is under execution by a slave portable terminal is large, the slave portable terminal does not transmit a response to the master portable terminal and thereby, any degradation of the performance can be prevented when an app is executed by the parallel processing.

The control method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

The portable terminal described in this embodiment may be, for example, a portable telephone (a smartphone or a personal handy-phone system (PHS)), a tablet terminal, or a mobile personal computer. The control terminal and/or the request destination terminal may be a desktop personal computer or a server.

An aspect of the embodiments enables the performance of an app executed by sequential processing to be ensured.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A control terminal that is configured to enable access of a storage apparatus storing a first processing time period that is consumed when an application that is to be executed is executed by sequential processing and a second processing time period that is consumed when the application is executed by parallel processing, the control terminal comprising
a processor that is configured to:
transmit an execution request for the application to a request destination terminal upon accepting a startup instruction for the application;
receive from the request destination terminal, a response to the transmitted execution request;
determine whether a sum of the second processing time period and a difference of a reception time of the response and a transmission time of the execution request, is at least equal to the first processing time period; and
execute the application by sequential processing by the control terminal upon determining that the sum is at least equal to the first processing time period, and execute the application by parallel processing using the control terminal and the request destination terminal upon determining that the sum is not at least equal to the first processing time period.

2. The control terminal according to claim 1, wherein
the processor receives the response from each request destination terminal when the request destination terminal is present in plural,
the processor determines whether a sum of the second processing time period and a difference of a reception time that is latest among reception times of the received responses and the transmission time of the execution request, is at least equal to the first processing time, and
the processor executes the application by sequential processing by the control terminal upon determining that the sum is at least equal to the first processing time period, and executes the application by parallel processing using the control terminal and the request destination terminals upon determining that the sum is not at least equal to the first processing time period.

3. The control terminal according to claim 1, wherein
the storage apparatus stores the number of dispatch sessions necessary when the application is executed by parallel processing,
the processor determines whether a sum of the second processing time period and a product of the difference multiplied by the number of dispatch sessions, is at least equal to the first processing time period, and
the processor executes the application by sequential processing by the control terminal upon determining that the sum is at least equal to the first processing time period, and executes the application by the parallel processing using the control terminal and the request destination terminals upon determining that the sum is not at least equal to the first processing time period.

4. The control terminal according to claim 1, wherein
the processor receives the response within a specific time period from the transmission time of the execution request.

5. The control terminal according to claim 1, wherein
the processor transmits shared data of the application as the execution request for the application.

6. A control method that is executed by a control terminal that is configured to enable access of a storage apparatus storing a first processing time period that is consumed when an application that is to be executed is executed by sequential processing and a second processing time period that is consumed when the application is executed by parallel processing, the control method comprising:
transmitting an execution request for the application to a request destination terminal upon accepting a startup instruction for the application;
receiving from the request destination terminal, a response to the transmitted execution request;
determining whether a sum of the second processing time period and a difference of a reception time of the response and a transmission time of the execution request, is at least equal to the first processing time period; and
executing the application by sequential processing by the control terminal upon determining that the sum is at least equal to the first processing time period, and executing the application by parallel processing using the control terminal and the request destination terminal upon determining that the sum is not at least equal to the first processing time period.
